(19) United States
(12) Patent Application Publication
(10) Pub. No.: US 2009/0119636 A1
(43) Pub. Date: May 7, 2009

(54) INSTRUMENTING A COMPILED SOFTWARE ROUTINE FOR AUGMENTATION

(76) Inventors: Paul Kettley, Winchester (GB); Ian J. Mitchell, Eastleigh (GB); Stephen J. Wood, Portsmouth (GB)

Correspondence Address: HOFFMAN WARNICK LLC, 75 STATE ST, 14 FL, ALBANY, NY, 12207, US

(21) Appl. No.: 12/211,915

(22) Filed: Sep. 17, 2008

(30) Foreign Application Priority Data
Nov. 2, 2007 (EP) 07119898.0

(51) Int. Cl. G06F 9/44

(52) U.S. Cl. 717/100

(57) ABSTRACT

A method for instrumenting a compiled software routine including a sequence of compiled software instructions. An embodiment of the invention includes a method for selecting one of the compiled software instructions as a point in the software routine for augmentation; and supplementing the selected instruction so that, in execution, an event is generated at the selected instruction.

### FIELD OF THE INVENTION

The present invention relates to instrumenting compiled software routines. In particular, it relates to instrumenting compiled software routines for augmentation.

### BACKGROUND OF THE INVENTION

In enterprise systems including legacy software, such as aging software, there is a reluctance to change the legacy software due to a risk that the software may operate unpredictably or inefficiently. The extent of this problem can increase with the age of legacy software and the level of documentation, support, and developer experience recedes. However, it is often necessary for the operation of such legacy software to be adapted, supplemented or otherwise affected in order to provide facilities and services required of modern data processing systems. It would be most advantageous if such changes to legacy software did not necessitate the rewriting or replacement of the software where the software is otherwise considered to be reliable and effective.

In the prior art, aspect oriented programming techniques are employed to weave aspects of code into predefined join-points within a software application. The use of aspect oriented programming techniques is not effective in addressing the aforementioned problem for at least two reasons. Firstly, applications for which aspect oriented programming approaches are applied must be developed with aspect oriented programming in mind and must therefore be architected accordingly so as to be parsed by an aspect weaver. Legacy software may exist in only its compiled form, such as a machine code executable form, and is not necessarily developed in an aspect oriented programming language (such as have been available only relatively recently, and as are discussed in Issued U.S. Pat. No. 6,467,086 Assigned to Xerox Corporation). Secondly, in order to strictly define points in a legacy application for the purpose of aspect weaving, it would be necessary to be able to uniquely identify such points by way of satisfying an aspect rule. In any event, to employ technology such as aspect oriented programming for legacy systems it will be necessary to provide aspect support for legacy programming languages (including Cobol, PL/1, Fortran and assembly languages) and a recompilation of the legacy system will be required to weave newly developed aspect code for inclusion into resulting executable binaries. Such a development would involve substantial effort possibly correlating to the effort required to replace a legacy system.

Another technology available in the prior art involves executing software routines in a special mode known as “debug mode”. Debug mode provides for the setting of breakpoints and effecting changes to an application state interactively by a software developer during software development. Such debug technologies require that applications include debug code (such as data definitions and references to source code) that result in a larger runtime executable and poor runtime performance. Consequently, debug code is normally not included in production runtime binaries since these require high performance and are not intended to be run with an interactive debugger. Furthermore, a decision to include debug code into a software routine is made at build-time, and legacy software available only in its compiled runtime production form cannot necessarily be rebuilt (i.e., recompiled, linked and packaged). Yet further, the function of such a debug mode is specifically directed to providing problem determination and resolution facilities at development time, and involves interactive use of debugger software by a software developer. It is unlikely to be acceptable to involve a software developer interactively in supplementing a legacy software routine at production runtime.

### SUMMARY OF THE INVENTION

The present invention accordingly provides, in a first aspect, a method for instrumenting a compiled software routine comprising a sequence of compiled software instructions, the method including: selecting one of the compiled software instructions as a point in the software routine for augmentation; and supplementing the selected instruction so that, in execution, an event is generated at the selected instruction.

In this way, a legacy software routine in its compiled form can be instrumented to generate an event at a point in its execution where augmentation is required. The event can be a software event for communication to other software routines in execution, and further the event can be one of: a function call; method call, and subroutine call to at least one of the other software routines in execution. The communication of such an event to another software routine provides for the augmentation of the compiled software routine by way of the other software routine. For example, additional functionality, procedures, subroutines, data manipulations or enhancements can be provided in a software routine receiving the event, which can be communicated via a network. Supplementing the selected instruction can include inserting one or more software instructions for generating the event in execution. The selected one of the software instructions can include specifying the selected instruction as an offset from a base software instruction in the compiled software routine.

The present invention accordingly provides, in a second aspect, an apparatus for instrumenting a compiled software routine comprising a sequence of compiled software instructions, the apparatus including: means for selecting one of the software instructions as a point in the software routine for augmentation; and means for supplementing the selected instruction so that, in execution, an event is generated at the selected instruction.

The present invention accordingly provides, in a third aspect, an apparatus comprising: a central processing unit; a memory subsystem; an input/output subsystem; and a bus subsystem interconnecting the central processing unit, the memory subsystem, the input/output subsystem; and the apparatus as described above.

The present invention accordingly provides, in a fourth aspect, a computer program element comprising computer program code to, when loaded into a computer system and executed thereon, cause the computer to perform the steps of a method as described above.

### BRIEF DESCRIPTION OF THE DRAWINGS

An embodiment of the present invention is described below in more detail, by way of example only, with reference to the accompanying drawings.

FIG. 1 is a block diagram of a computer system suitable for the operation of embodiments of the present invention.

FIG. 2 is a schematic diagram of a compiled software routine for instrumentation in accordance with a preferred embodiment of the present invention.

FIG. 3 is a flowchart of a method for instrumenting the compiled software routine in accordance with a preferred embodiment of the present invention.

FIG. 4 is a flowchart of a method of executing the compiled software routine instrumented in accordance with the method of FIG. 3 in accordance with a preferred embodiment of the present invention.

### DETAILED DESCRIPTION OF THE INVENTION

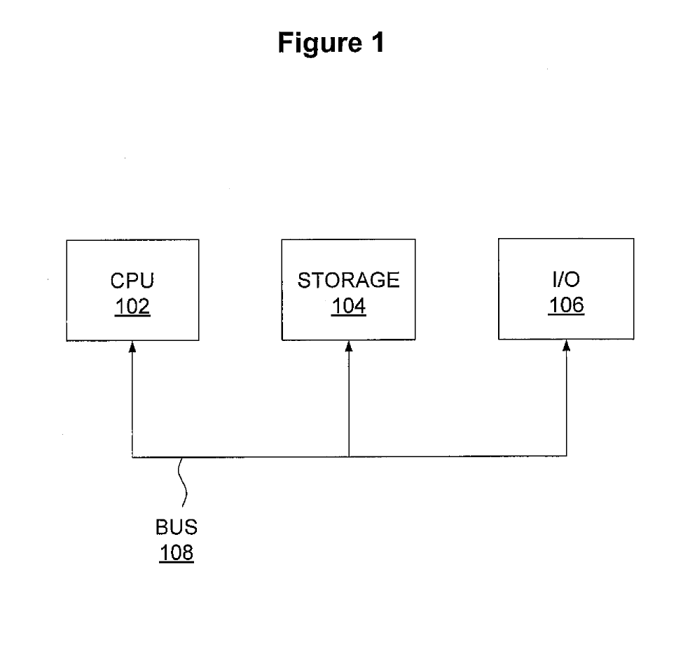

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

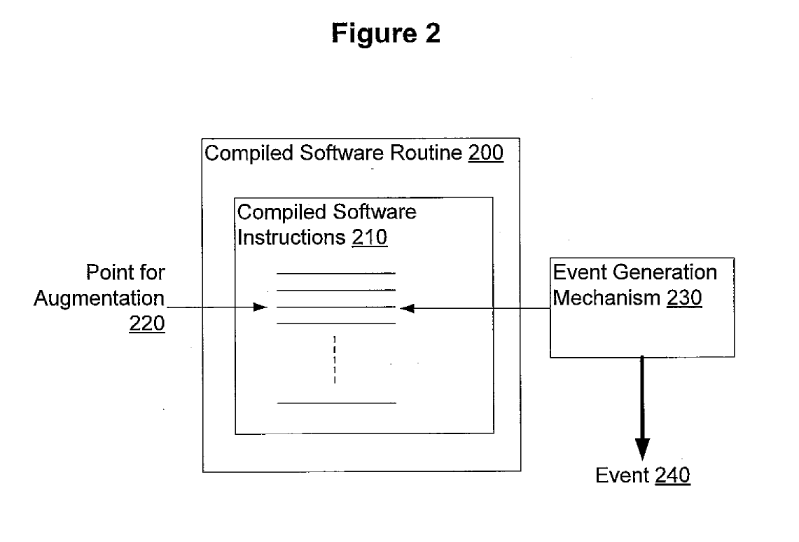

FIG. 2 is a schematic diagram of a compiled software routine 200 for instrumentation in accordance with an embodiment of the present invention. Software routine 200 is a software module or component such as a computer program in a compiled form. For example, software routine 200 is a legacy software routine in a binary executable form, or a software routine having been previously compiled to machine code or assembly language. The software routine 200 comprises compiled software instructions 210 illustrated generally in FIG. 2. Such instructions can be in machine code or assembly language suitable for interpretation by a microprocessor or the like. The compiled software routine 200 and software instructions 210 are the product of a software compiler (such as a programming language compiler). Alternatively, the software routine 200 and the software instructions 210 are all or partly compiled manually, having been provided directly by a software developer as has been known to be common in historical software development and also in contemporary software development, such as to achieve high performance.

FIG. 2 illustrates how a single one of the software instructions 210 is selected as a point for augmentation 220. The selected software instruction at the point for augmentation 220 corresponds to a location in the software instructions 210 at which augmentation of the software routine 200 is required. Augmentation can include providing further software instructions for providing additional functionality, procedures, subroutines, data manipulations or enhancements. For example there may be a requirement to supplement the functionality of the software routine 200 with further logic (by way of further software instructions). The point for augmentation 220 indicates where such further functionality is required. The point for augmentation 220 can be any reference in the compiled software instructions 210 suitable for identifying the instruction at which augmentation is required. For example, the point for augmentation 220 can be an address of a software instruction, or an offset from a base software instruction in the software routine 200.

The point for augmentation 220 is preferably selected by a software developer on the basis of a requirement for augmenting the software routine 200. Conceivably the point for augmentation 220 may be identified by an automated procedure searching for aspects of the compiled software instructions 210 that satisfy certain predetermined criteria. For example, in the event of a requirement to augment the software routine 200 to enact a change in a format for certain data items (such as a ‘date’ format or a COBOL picture clause), software instructions 210 involved in the use of the existing data format can be identified and augmentation points defined corresponding to their location in the software routine 200.

FIG. 2 further includes an event generation mechanism 230. The event generation mechanism 230 is a software or hardware component operable to supplement the selected software instruction at the point for augmentation 220 so that, in execution, an event 240 is generated at the selected instruction. The event 240 can be generated before or after the selected instruction, as is desired by any particular implementation of an embodiment of the present invention. The event generation mechanism 230 is any mechanism suitable for generating the event 240 at the point for augmentation 220.

In one embodiment, the event generation mechanism 230 involves introducing an intermediate software instruction within the software instructions 210 that is operable to generate an event 240. The introduction of such an intermediate software instruction might involve shifting software instructions 210 to accommodate a new software instruction. Further, such an intermediate software instruction may be a single instruction, such as a single event generating instruction or a branch instruction to a subroutine operable to generate the event 240. Alternatively, such an intermediate software instruction may be a set of multiple instructions operable to generate the event 240.

In an alternative embodiment, the event generation mechanism 230 includes a software monitor operable to examine the state of execution of the software instructions 210 and being adapted to identify when, during the execution of the software routine 200, the selected instruction at the point for augmentation 220 is executed. In response to this identification the event 240 can be generated by the software monitor. For example, such a software monitor can be a hardware or software routine to which the execution state of the compiled software routine 200 is accessible.

In a yet further alternative embodiment, the event generation mechanism 230 employs a software “trap”, such as is exemplified by microprocessors of the kind deriving from the x86 architecture of microprocessors, in which a dedicated processor register, flag or bit is provided to indicate when the processor should enter a software trap. A software trap is a special mode of execution in which execution can be intercepted. For example, the 8088 (and subsequent) microprocessor from Intel Corporation includes a trap flag register for, when set, causing the processor to enter a “single-step” mode in which an interrupt numbered 0x1H is issued after the execution of every software instruction. Thus an event generation mechanism 230, being a software or hardware component operable to set a trap flag at the point for augmentation 220, can operate responsively to the issuance of interrupt 0x1H in order to cause the generation of the event 240. For example, such an event generation mechanism 230 can insert a machine code instruction immediately before (or immediately after) the software instruction at the point for augmentation to set the trap flag.

The event 240 is any mechanism suitable for consumption or receipt by, or communication to, other software routines in execution for providing augmenting software instructions. Such other software routines are thus operable to undertake the actual augmentation of the compiled software routine 200, such as by providing further software instructions for providing additional functionality, procedures, subroutines, data manipulations or enhancements. For example, the event 240 is a software event such as a data message suitable for transmission between software routines. Alternatively, event 240 is a function call, a method call, a branch to a subroutine, a jump to a predetermined set of software instructions, an interrupt, a software or hardware exception or a network message. In some embodiments the event 240 is communicable via a network, such as where an augmenting software routine is provided at a different computer system.

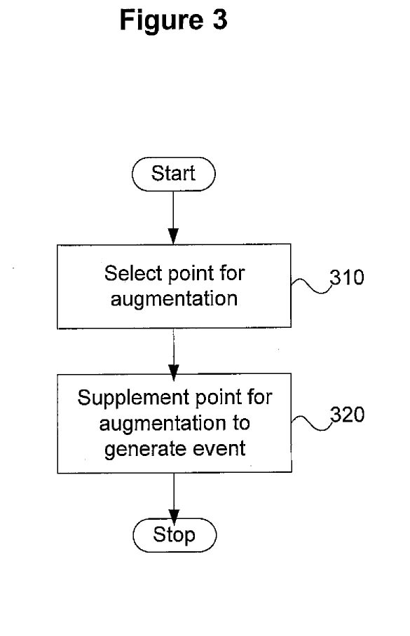

FIG. 3 is a flowchart of a method for instrumenting the compiled software routine 200 in accordance with an embodiment of the present invention. Initially, at step 310, a point for augmentation 220 in the compiled software instructions 210 is selected. Subsequently, at step 320, the point for augmentation is supplemented by the event generation mechanism 230 to generate the event 240 at runtime when the execution of the compiled software routine 200 reaches the point for augmentation 220.

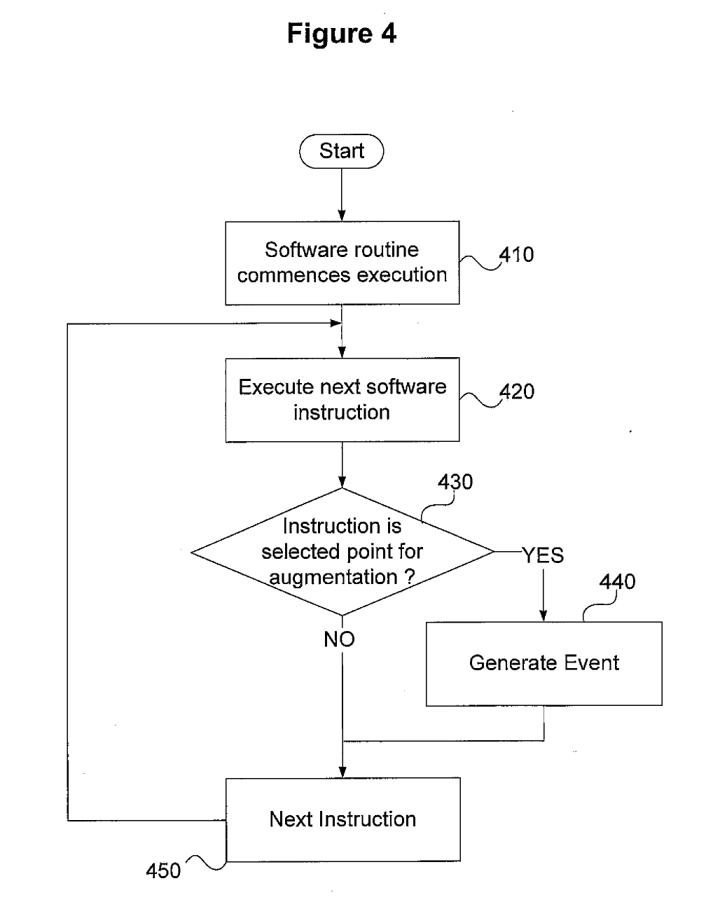

FIG. 4 is a flowchart of a method of executing the compiled software routine 200 instrumented in accordance with the method of FIG. 3 in accordance with an embodiment of the present invention. Initially, at step 410, the software routine 200 commences execution. For example, execution of the software routine 200 involves sequential execution of each of the compiled software instructions 210 in CPU 102. Accordingly, at step 420, the method executes a next software instruction. At step 430 the method determines if the current instruction corresponds to the point for augmentation 220. The determination of step 430 can be made actively (e.g., by an event generation mechanism 230 that is monitoring the execution of the software routine 200), or passively (e.g., by an event generation mechanism 230 that inserts additional instructions into the compiled software routine 200, or by the use of a trap flag). If the point for augmentation has been reached, the method proceeds to step 440 where the event 240 is generated. Subsequently, the next instruction is processed from step 450 by iterating to step 420.

Thus, in use, the compiled software routine 200 is instrumented by the definition of a point for augmentation 220 and an event generation mechanism 230 that is operable to cause the generation of event 240 when execution of the compiled software instructions 210 reaches the point for augmentation 220. The communication of such an event to another software routine provides for the augmentation of the compiled software routine 200 by way of the other software routine. For example, additional functionality, procedures, subroutines, data manipulations or enhancements can be provided in a software routine receiving the event.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A method for instrumenting a compiled software routine comprising a sequence of compiled software instructions, the method comprising:
selecting one of the compiled software instructions as a point in the software routine for augmentation; and
supplementing the selected instruction so that, in execution, an event is generated at the selected instruction.

2. The method of claim 1, wherein the event is a software event for communication to other software routines in execution.

3. The method of claim 2, wherein the event is one of: a function call; method call, and subroutine call to at least one of the other software routines in execution.

4. The method of claim 2, wherein the event is communicable via a network.

5. The method of claim 2, wherein supplementing the selected instruction includes inserting one or more software instructions for generating the event in execution.

6. The method of claim 2, wherein the selected one of the software instructions includes specifying the selected instruction as an offset from a base software instruction in the compiled software routine.

7. An apparatus for instrumenting a compiled software routine comprising a sequence of compiled software instructions, the apparatus comprising:
means for selecting one of the software instructions as a point in the software routine for augmentation; and
means for supplementing the selected instruction so that, in execution, an event is generated at the selected instruction.

8. The apparatus of claim 7, wherein the event is a software event for communication to other software routines in execution.

9. The apparatus of claim 8, wherein the event is one of: a function call; method call, and subroutine call to at least one of the other software routines in execution.

10. The apparatus of claim 8, wherein the event is communicable via a network.

11. The apparatus of claim 8, wherein supplementing the selected instruction includes inserting one or more software instructions for generating the event in execution.

12. The apparatus of claim 8, wherein the selected one of the software instructions includes specifying the selected instruction as an offset from a base software instruction in the compiled software routine.

13. A computer program element for instrumenting a compiled software routine comprising a sequence of compiled software instructions, when loaded into a computer system and executed thereon, comprising program code for:
selecting one of the compiled software instructions as a point in the software routine for augmentation; and
supplementing the selected instruction so that, in execution, an event is generated at the selected instruction
